(19) United States
(12) Patent Application Publication
(10) Pub. No.: US 2009/0218735 A1
(43) Pub. Date: Sep. 3, 2009

(54) METHOD OF SYNTHESIS OF CERAMICS

(75) Inventors: Aslan Khajimuratovich Abduev, Moscow (RU); Abil Shamsudinovich Asvarov, Moscow (RU); Akhmed Kadievich Akhmedov, Moscow (RU); Ibragimkhan Kamilovich Kamilov, Moscow (RU)

Correspondence Address: BANNER & WITCOFF, LTD., 1100 13th STREET, N.W., SUITE 1200, WASHINGTON, DC, 20005-4051, US

(73) Assignee: OTKRYTOE AKTSYONERNOE OBSHCHESTVO "POLEMA", Tula (RU)

(21) Appl. No.: 12/063,727

(22) PCT Filed: Aug. 16, 2005
(86) PCT No.: PCT/RU2005/000421

§ 371 Date: Jul. 25, 2008

(51) Int. Cl. C04B 35/64; C04B 35/453

(52) U.S. Cl. 264/678; 264/681

(57) ABSTRACT

The present invention relates to producing ceramic targets, which serves as a material source for magnetron, electron-beam, ion-beam and other film applying methods in micro-, opto-, nano-electronics. The aim of the proposed invention is to reduce the doping level of ceramics by non-controllable impurities, to increase a ceramic density and to improve performance characteristics of ceramic targets. In the method for synthesizing the ceramics doped by a low-melting metal consisting in that a mixture of components is pressed and sintered; as a doping additive, the mixture of components contains a low-melting metal and the surface of the main component particles is covered and moistened prior to pressing by the doping metal layer by grinding the mixture of the components. The grinding can be carried out at a melting temperature of the low-melting metal. In a particular case, for the synthesis of zinc oxide ceramic doped with gallium, the mixture of zinc oxide powder with gallium is triturated at a gallium melting temperature. The component mixture can contain a boron compound, as a binder and a doping additive, forming boron oxide during sintering.

### FIELD OF THE INVENTION

The present invention relates to the production of ceramic materials area and is intended for use in manufacturing ceramic targets comprising a source of material for magnetron, electron-beam, ion-beam and other methods for applying films in micro-, opto-, nano-electronics.

### DESCRIPTION OF THE PRIOR ART

Synthesis methods of ceramics consisting in that mixtures of components are prepared, pressed and sintered are known [J. M. Tairov, V. F. Tsvetkov. “Technology of semi-conducting and dielectric materials”, Moscow, “Higher School” Publishing House, 1990, 423 pages].

The prototype of the proposed method is a ceramic synthesis method consisting in that a mixture of components is prepared out of powders of a main substance oxide, a doping metal oxide and an additive promoting sintering of components particles and then it is pressed and sintered [U.S. Pat. No. 5,458,753, published Oct. 17, 1995, “Transparent conductive films consisting of zinc oxide and gallium”].

For example, for the preparation of zinc oxide ceramics doped with gallium the mixture is prepared out of powders of zinc oxide, gallium oxide and a binder. After the annealing of the mixture, its pressing and sintering, the ceramic material is formed consisting of sintered zinc oxide particles doped with gallium, inclusions of gallium oxide and containing the reaction products of the mineralizer. Such a ceramics is used as ceramic targets for sputtering layers in micro- and opto-electronics, which are very critical to the impurities. The contents of an independent gallium oxide phase and the combustion products of mineralizer in the ceramic composition reduce performance characteristics of the ceramics.

### SUMMARY OF THE INVENTION

The purpose of the proposed invention is a reduction of the doping level of ceramics by non-controllable impurities, increasing a density of ceramics, improvement of performance characteristics of ceramic targets on the basis of a material doped by a low-melting metal used in micro-, nano-, opto-electronics for forming transparent conductive electrodes, dielectric and semi-conductive layers.

The indicated technical result is obtained by the fact that in the method for synthesizing the ceramic doped by a low-melting metal wherein a mixture of components is pressed and sintered, the mixture of components contains a low-melting metal as a doping additive, and the surface of the main component particles is covered and moistened by the doping metal layer by grinding the mixture of components prior to pressing. Grinding can be carried out at a melting temperature of the low-melting metal.

In a particular case, for the synthesis of zinc oxide ceramics doped with gallium, the mixture of zinc oxide powder with gallium is ground at a temperature sufficient for melting gallium.

In any variant, the component mixture, as a binder and doping additive, can contain a boron compound forming during the sintering the boron oxide, which improves the conditions of sintering providing a liquid phase at the grain boundaries. During annealing the ceramics is doped with boron, which acts as a donor admixture and increases the electric conductivity of ceramics.

In the process of grinding the mixture of the main component and the doping low-melting metal, moistening of the main component by the metal occurs. Said moistening is carried out at relatively low temperatures providing an evenly applying of small quantities of the additive on the surface of the main material nanoparticies. Such a distribution of the additive creates optimum conditions for doping of the main material particles and producing ceramic targets providing the synthesis of transparent electrodes.

When pressing the metal layer serves as a lubricant and reduces friction forces between the main substance particles, that allows producing less strained and more dense articles.

During the sintering (annealing) of the articles the metal, which moistens the surface of the main material particles is held on the particles surface by the forces of a surface tension and is not distributed trough the volume of ceramics. The uniform distribution of the doping material on the surface of the main material improves the doping conditions and permits substantially to reduce (or eliminate) the formation of the doping metal oxide phase in the ceramics. At the same time, on the grain boundaries a phase with a low temperature of melting is formed that contributes to acceleration of diffusion and ceramics sintering processes.

In order to accelerate the process of preparing the mixture of the raw materials, the process of triturating, sometimes, is carried out at a doping metal melting temperature.

### DESCRIPTION OF THE PREFERRED EMBODIMENT OF THE INVENTION

An Example of an embodiment of the proposed invention is a method of producing a ceramic target prepared from zinc oxide doped with gallium, consisting in that a mixture of zinc oxide powder and 2-weight % of metallic gallium is prepared. This mixture is ground in a ceramic dish till complete gallium transferring on the surface of zinc oxide particles. The prepared mixture is placed into a press mold and is pressed at a pressure of 800-1000 atm. (˜10⁸ Pa).

The pressed plate is held in the open atmosphere at a temperature of 1250-1300° C. within about 5 hours.

The obtained ceramics has a density of about 5.65 g/cm³, what constitutes 99.5% of theoretical density thereof.

For testing a round target in the form of ceramic plate having the diameter 100 mm and thickness 6 mm was placed on the surface of a DC magnetron. Preliminary a metallic covering was applied on the lower side of the target for providing the electric and thermal contact.

The tests showed that the multiple sputtering at currencies up to 0.5 A did not lead to destruction (cracking) of the target.

The obtained layers had the following characteristics:

| Transmittance in the spectral range of 450-650 nm | about 90% |
|---|---|
| Surface resistance, Rₛ, Om/□ | 10-20 |

The carried out tests indicate that the prepared layers correspond to the requirements to the transparent conductive electrodes, and the proposed ceramics has high performance characteristics.

The introduction of boron oxide or compounds, which in the process of annealing forms a boron oxide, into the mixture composition permits to create a liquid phase of boron oxide at the grain boundaries in the process of sintering substantially improving the conditions of sintering and density of the synthesized ceramics. Thus, the annealing of ceramics containing 1-5 weight % of gallium and 1-5 weight % of boron at a temperature about 1350° C. leads to the synthesis of ceramics with a high density. In the process of forming the ceramics the boron oxide plays the role of the binder and in layers synthesized from this ceramics—the role of an additional doping additive substantially improving the electric characteristics of the formed films.

The ceramics of zinc oxide doped with gallium and boron ZnO:Ga:B (GZOB) is intended for the synthesis of high-quality transparent electrodes used in solar elements and in liquid-crystal displays. Gallium and boron contained in the composition of the ceramics are doping admixtures for creating n-type conductivity in zinc oxide. The use of ceramics of the claimed composition based on zinc oxide with gallium and boron additives as targets for the synthesis of thin-film transparent electrodes allows to substantially improve the structure, to reduce the electric resistance and to increase mobility of charge carriers. The synthesis of the layers from the claimed ceramic material leads to suppressing the growth of columnar structures and to high uniformity of layers. The increase of layers uniformity excludes a diffusion of etching agents along the grain boundaries and improves chemical resistance thereof.

1. A method for synthesizing a boron-containing ceramics doped by a low-melting metal consisting in that a mixture of components is pressed and sintered, wherein the mixture of components contains a low-melting metal as a doping additive, the compound of boron as a binder and a doping material is introduced into the mixture of components and the surface of the main component particles is covered prior to pressing with a layer of the doping metal by grinding the mixture of the components.

2. The method according to claim 1, wherein the grinding is carried out at a melting temperature of the low-melting metal.

3. The method according to claim 1, wherein for synthesizing the zinc oxide ceramics doped by gallium the mixture of zinc oxide powder with gallium is ground at the temperature sufficient for melting gallium.

4. The method according to claim 2, wherein for synthesizing the zinc oxide ceramics doped by gallium the mixture of zinc oxide powder with gallium is ground at the temperature sufficient for melting gallium.
